(19) United States
(12) Patent Application Publication
(10) Pub. No.: US 2004/0074563 A1
(43) Pub. Date: Apr. 22, 2004

(54) Method and system for optimizing log harvesting

(75) Inventors: Leonard E. MacNeil, Kamloops (CA); Stephane Pigeon, Beloeil (CA); Daniel Landry, St-Jean-Sur-Richelieu (CA)

Correspondence Address: AKERMAN SENTERFITT, P.O. BOX 3188, WEST PALM BEACH, FL, 33402-3188, US

(73) Assignee: Denharco Inc., Saint-Hyacinthe (CA)

(21) Appl. No.: 10/427,372

(22) Filed: May 1, 2003

(30) Foreign Application Priority Data
Mar. 5, 2002 (CA) 2,384,914

(51) Int. Cl. A01G 23/08

(52) U.S. Cl. 144/335; 144/4.1

(57) ABSTRACT

A method for optimizing log harvesting from a model of a delimbered tree trunk which comprises selecting an optimization mode and obtaining an optimized log cutting solution, whereby the optimized log cutting solution indicates optimized localizations along the delimbed tree trunk.

### FIELD OF THE INVENTION

The present invention relates to log harvesting. More specifically, the present invention is concerned with a method and a system for optimizing log harvesting.

### BACKGROUND OF THE INVENTION

In the log harvesting field, millions of dollars are spent each year by mills in efforts to develop harvesting plans allowing log harvesting improvements to optimize the use of each log while at the same time complying with standard quality requirements.

Harvesting heads, such as the one shown in FIG. 1, may be used in delimbing operations. Typically, such a harvester head 10, mounted at the end of an articulated arm of a boom (not shown), has a limited supporting action on a trunk and cannot usually hold the trunk of a large tree by the top thereof without resulting in the trunk to break off. Harvesting heads are generally used in a delimbing mode wherein a trunk is hold between arms by the action of clamps such as Soft Clamp™, and the trunk is driven by rotation of feed rolls. The length and the diameter of the trunk may be measured during the delimbing process.

Harvesting heads have a number of drawbacks and limitations. For example, it proves generally complex to obtain a complete model of the trunk in a delimbing stage performed by the harvester head 10 since, in particular, it cannot functionally process to a top diameter and then come back to a preset position from the butt of a trunk, due to a number of reasons, including for example the followings. In particular, when the harvesting head 10 reaches a part of a trunk of a 3′-4″ diameter, its grip on the trunk is largely decreased, especially when the weight is on the butt side of the harvesting head 10: the harvesting head typically spins out, or breaks the top and looses the grip on the trunk. In cases when the harvesting head 10 spins out at the top of the trunk, the measurements are impaired and the process has to be started again. In effect, when the harvesting head 10 spins out, the arms thereof are to be bumped open and fed in reverse, which causes the trunk to drop from the measuring wheel of the harvesting head, resulting in inaccuracy and poor quality. Besides, just running the harvesting head to a top diameter of a trunk then reversing to the butt thereof, if possible, and then reprocessing from the butt, cause inaccuracy and poor production, not to mention further damages to the logs cut off the trunk. Therefore, achieving a modeling of a trunk with harvesting heads, which essentially cut the most preferred part off the butt regardless of the top log left to process, causing a lot of waste and lower value per stem, and resulting in an overall poor tree stand and block management, proves to be difficult.

As an alternative to harvesting heads, delimbing machines are also used, with the advantage that a model of the trunk is achieved more straightforwardly during the delimbing process.

The delimbing machine illustrated in FIGS. 2-6 is generally a sliding boom delimber. It comprises a body 30 supporting a boom 22. The boom 22 is a tubular element that is movable into a sleeve 23 under the action of a cable (not shown) pulled through a rope winch 25 on the sleeve 23. The boom 22 supports delimbing arms 16, 18, while holding arms 24, 26 are attached to the sleeve 23. Typically, the delimbing machine 12 is provided with a control unit (not shown).

In operation, the delimbing machine 12 provides that a tree trunk 14 is first seized and held in the jaws of the delimbing arms 16 and 18 while the holding arms 24 and 26 being in an open position (FIG. 2). As part of a modeling of the trunk, a bottom end 20 of the tree trunk 14 is then taken as a reference point in a manner that is believed to be well known in the art, for example by a butt saw located close to the holding arms 24 and 26, by a butt plate fixed at a known position, or by photocells located at the beginning of the sleeve 23 (not shown). Once this reference point is taken, the length of the trunk 14 is determined from that reference point by means of a sensor (not shown) mounted on a shaft of the rope winch 25. Then the holding arms 24 and 26 are closed to firmly secure the trunk 14 so that trimming by the delimbing arms 16, 18 may start. The delimbing arms 16, 18 are displaced with the boom 22 away from the fixed holding arms 24, 26, along the length of the trunk 14 to be trimmed (see FIG. 3) under a controlled pressure (by soft clamp™ for example), in such a way that branches 28 of the trunk 14 are cut off (see FIG. 4).

The delimbing machine 12 allows that the length and the diameter of the trunk 14 are measured and stored in a memory means (not shown). The diameter is measured at predefined intervals, for example at every other inch along the trunk 14. In cases when the length of the trunk 14 is larger than a maximum length of the boom 22, the trunk 14 may be backed up through a passageway 31 provided in the body 30 of the delimbing machine 12, the trunk 14 still being tightly secured by the delimbing arms 16, 18 while the holding arms 24 and 26 are in the open position, as is illustrated in FIG. 5. During this process, the relative measurement between the reference end 20 and the boom 22 is not varied (see FIG. 5), so that the measurements of the length of the trunk 14 are not impaired.

Once the holding arms 24, 26 are closed back again and the controlled working pressure of the delimbing arms 16, 18 is reestablished, the boom 22 resumes its movement, thereby allowing the delimbing to continue, simultaneously with the measurements of the length and diameter of the part of the trunk 14 that is still being delimbed. When the diameter of the trunk remaining to be delimbed ends up being below a predetermined size near a top 32 of the trunk 14, the top 32 of the trunk 14 is chopped away as is shown in FIG. 6. At that stage of the delimbing method, the length of the delimbed trunk 14 and the diameter of each section thereof are available in the memory means (not shown), thereby yielding a model of the trunk.

Still, it appears that the prior art fails to address a number of issues in the field of optimized log harvesting. In particular, current processes involve an operator dedicating time to try and make out proper decisions and calculate the most advantageous combinations, thereby accumulating mental stress and fatigue. Errors are inevitable, which are often caused by operators making the wrong decisions, hence resulting in lost revenue, due to fiber lost by not getting the best combinations out of the stem.

Therefore, there is a need for an optimized and reliable method and system enabling to make the most of the stems in log harvesting operations.

### OBJECTS OF THE INVENTION

An object of the present invention is therefore to provide an improved method and a system for optimizing log harvesting.

### SUMMARY OF THE INVENTION

More specifically, in accordance with the present invention, there is provided a method for optimizing log harvesting from a model of a delimbered tree trunk which comprises the steps of:

selecting an optimization mode; and

obtaining an optimized log cutting solution,

whereby the optimized log cutting solution indicates optimized localizations along the delimbed tree trunk.

Other objects, advantages and features of the present invention will become more apparent upon reading of the following non-restrictive description of embodiments thereof, given by way of example only with reference to the accompanying drawings.

### BRIEF DESCRIPTION OF THE DRAWINGS

In the appended drawings:

FIG. 1, which is labeled “Prior Art”, is a perspective view of a conventional harvesting head;

FIG. 2, which is labeled “Prior Art”, is a side elevational view of delimbing machine seizing a tree trunk;

FIG. 3, which is labeled “Prior Art”, is a side elevational view of the delimbing machine of FIG. 2 at the onset of the trimming process;

FIG. 4, which is labeled “Prior Art”, is a side elevational view of the delimbing machine of FIG. 2 at a further stage of the trimming process;

FIG. 5, which is labeled “Prior Art”, is a side elevational view of the delimbing machine of FIG. 2 when the tree trunk is being backed up;

FIG. 6, which is labeled “Prior Art”, is a side elevational view of the delimbing machine of FIG. 2 at a final stage of the trimming process when the top of the trunk is chopped away;

FIG. 7 is block diagram of the optimization method according to an embodiment of the present invention;

FIGS. 8a and 8b are examples of log preset tables used in the optimization method of FIG. 7;

FIG. 9 is a block diagram of a part corresponding to a test of predefined sequences in the optimization method of FIG. 7;

FIG. 10 is a block diagram of a part corresponding to value optimization in the optimization method of FIG. 7;

FIG. 11 is a block diagram of a sub-part of the value optimization part of FIG. 10;

FIG. 12 is a block diagram of a sub-part of the part of FIG. 11;

FIG. 13 is a block diagram of a part corresponding to priority optimization in the optimization method of FIG. 7;

FIG. 14 is a block diagram of a sub-part of the priority optimization part FIG. 13;

FIG. 15 is a block diagram of a pole filter method included in the optimization method of FIG. 7;

FIG. 16 illustrates a first example of display of a simulation test of optimization method of FIG. 7;

FIG. 17 illustrates a second example of a display of a system using the method of FIG. 7; and

FIG. 18 illustrates a display on a monitor unit used in a system using the method of the present invention.

### DESCRIPTION OF THE PREFERRED EMBODIMENT

Generally stated, the present invention provides a method and a system for optimizing log harvesting.

Starting from a model of a tree, the optimization log cutting method of the present invention will now be described in relation to FIGS. 7-15 of the appended drawings.

As shown in FIG. 7, the method 200 basically comprises selecting an optimization mode (step 220) and obtaining an optimization solution (step 260). It may further comprise using predefined tables (step 210) and applying a pole filter (step 230).

In step 220, an optimization mode is selected.

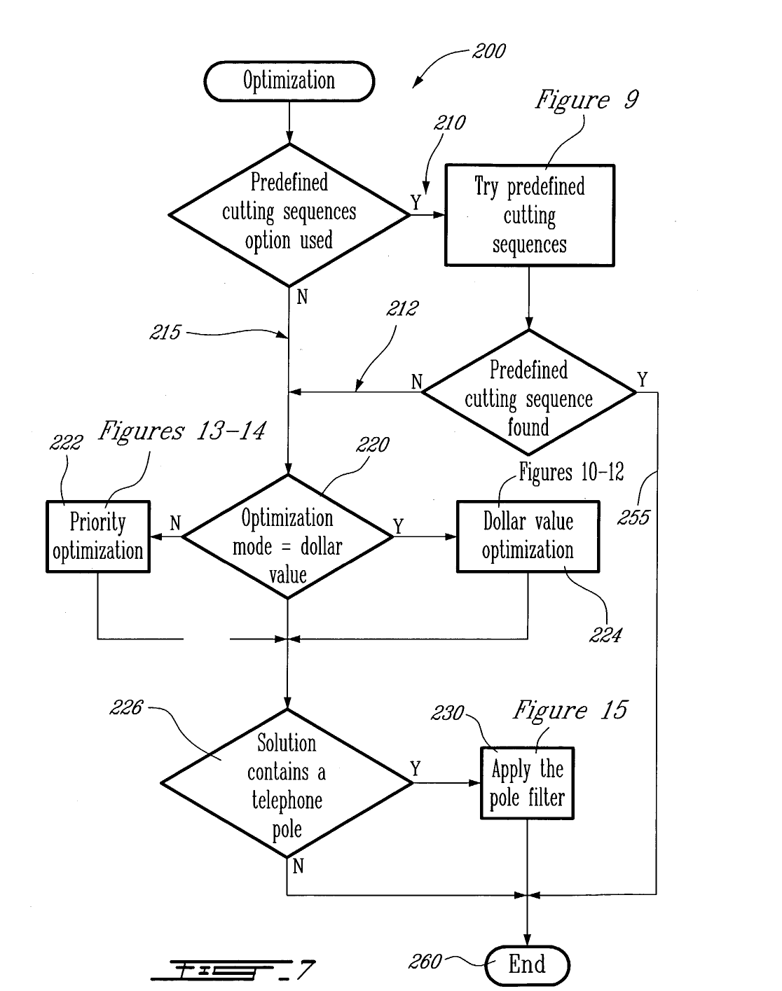

The method using the value mode is illustrated by the flowcharts of FIGS. 10 to 12. It may take into account a number of parameters including for instance market rates in relation to specific tree species and geometry of the trunk along its length.

When the optimization mode by dollar value is activated in step 224 of FIG. 7, the method goes on as illustrated in FIG. 10. After an initialization step (step 2240), a first preset value is selected from a preset table such as the table PRESETS described hereinbelow for the current specie of the trunk to be processed (step 2242) before a recursive function (Optimum_Value (Preset)) is launched (step 2244), which is illustrated by the flowchart diagram of FIG. 11.

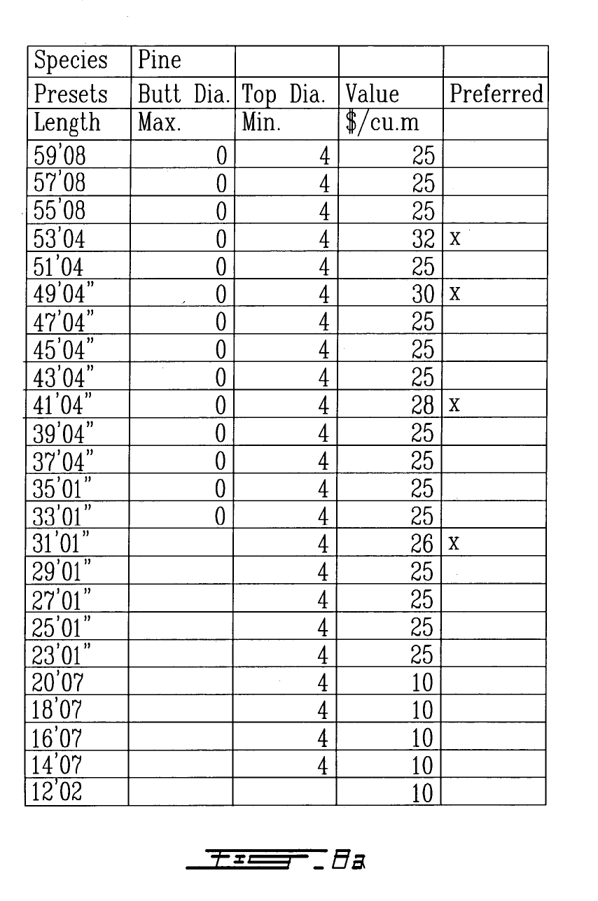

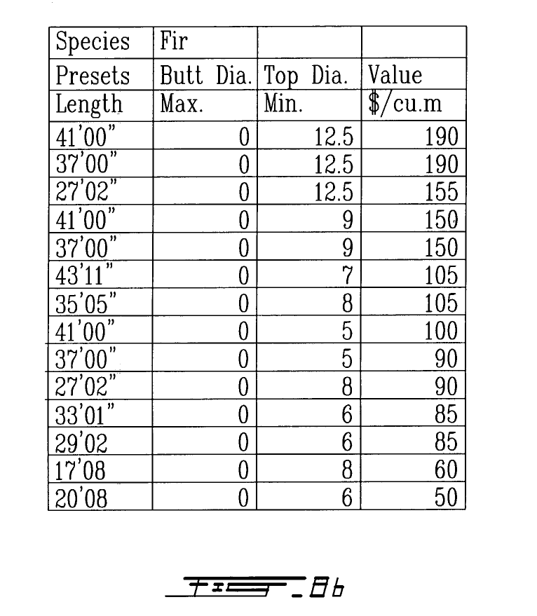

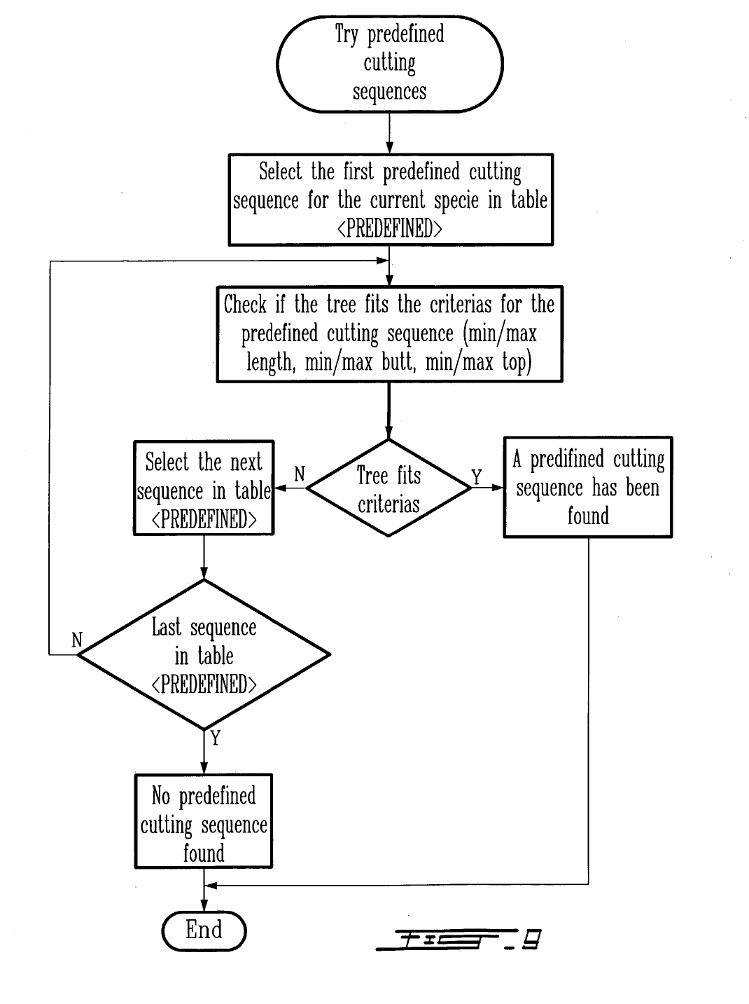

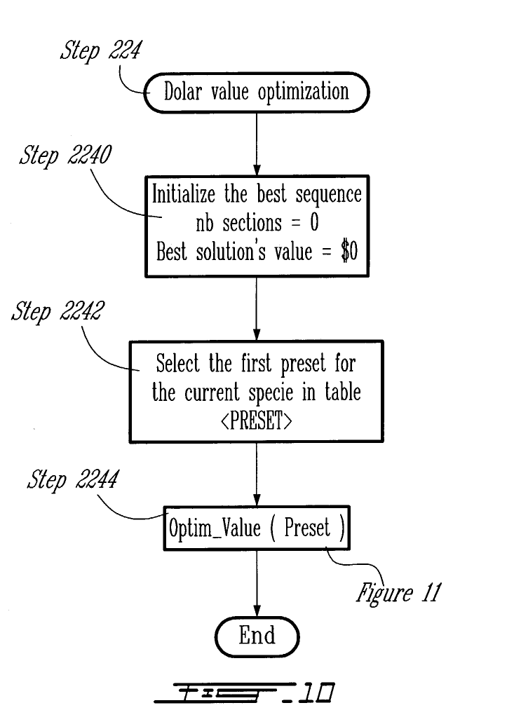

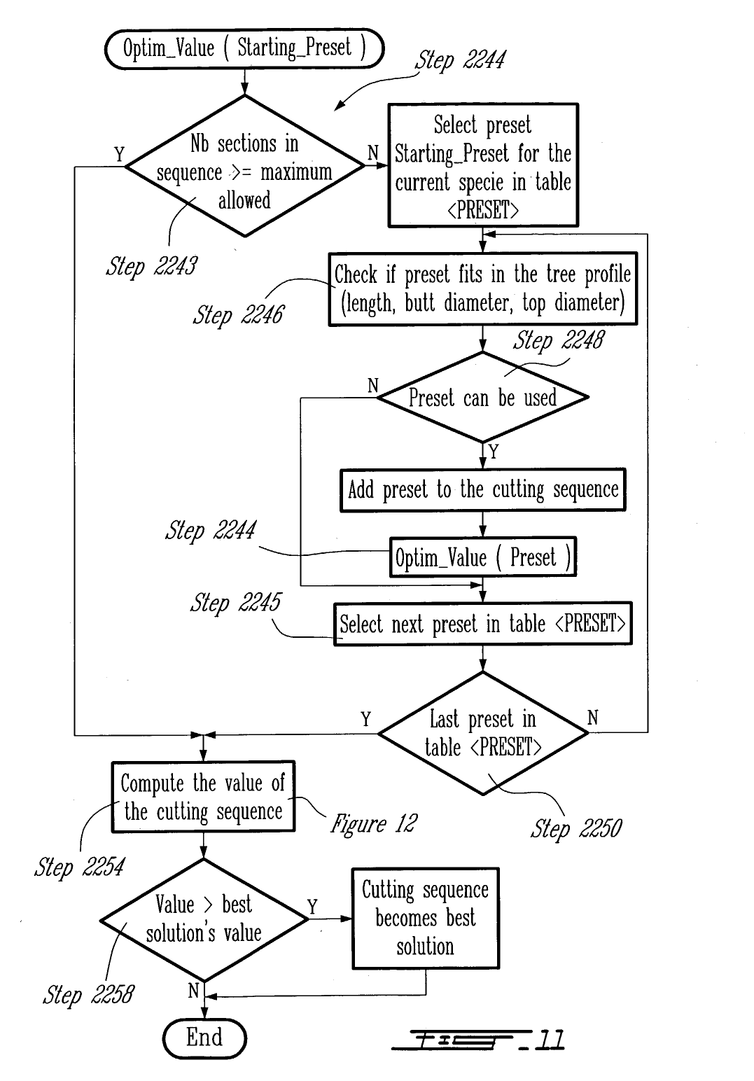

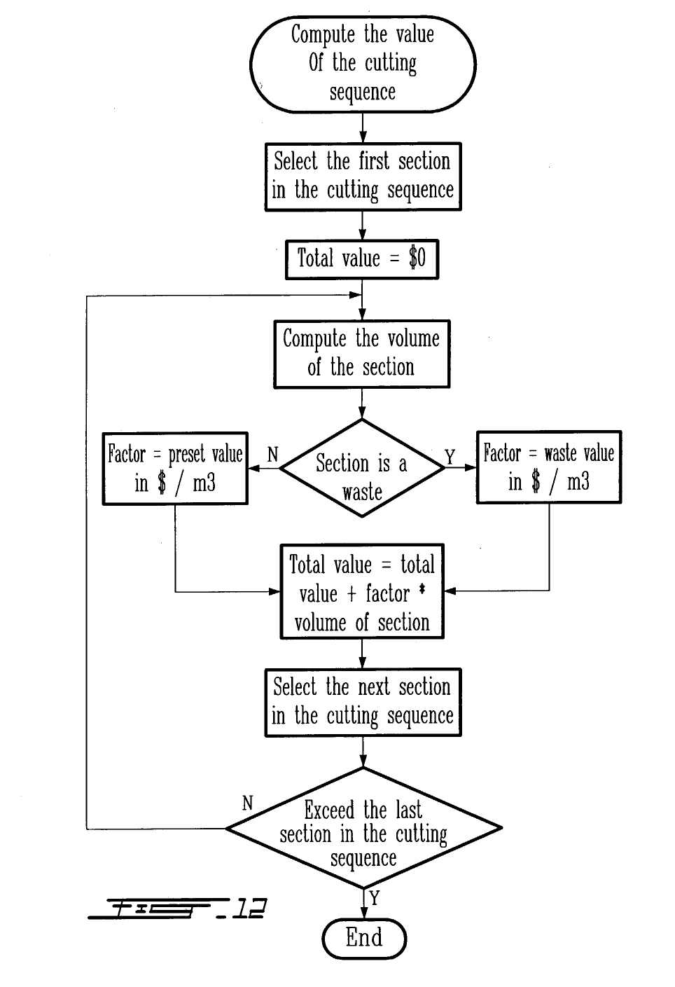

Given a constraint (step 2243), the recursive function (2244) builds up a most valuable cutting sequence from a tree model profile, available following the delimbing stage as explained hereinabove, by comparing (step 2246) and trying (2248) to fit combinations of preset values selected from the presets table (step 2245) with the current tree model. When all presets have been tried up to the last preset in the table (step 2250) or when the maximum number of sections allowed in a sequence has been reached (step 2243), the function 2244 quits, yielding a cutting sequence. Then a computation of the value of the cutting sequence obtained is performed (step 2254) as illustrated by the flowchart diagram of FIG. 12.

The computation of the value of the cutting sequence obtained takes into account each section of the cutting sequence to yield a value of the cutting sequence (step 2254). This value is then compared (step 2258) with previous values computed from previous cutting sequence solutions obtained from the recursive function 2244 solution provided by the recursive function 2244 at step 2254 to keep the more valuable one.

When the optimization mode by dollar value is not activated, the optimization of the cutting sequence is done by priority (step 222 FIG. 7)

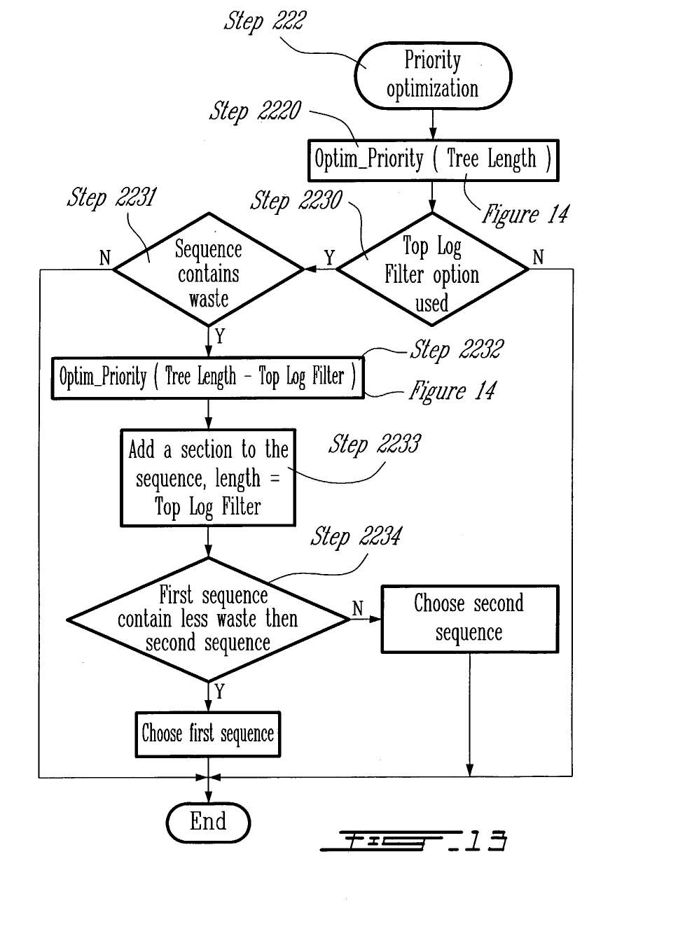

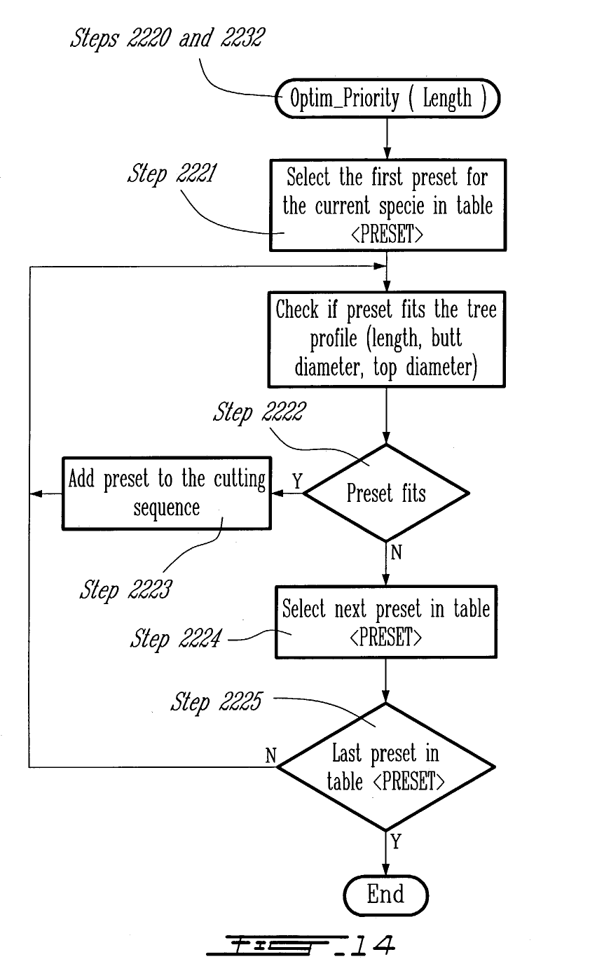

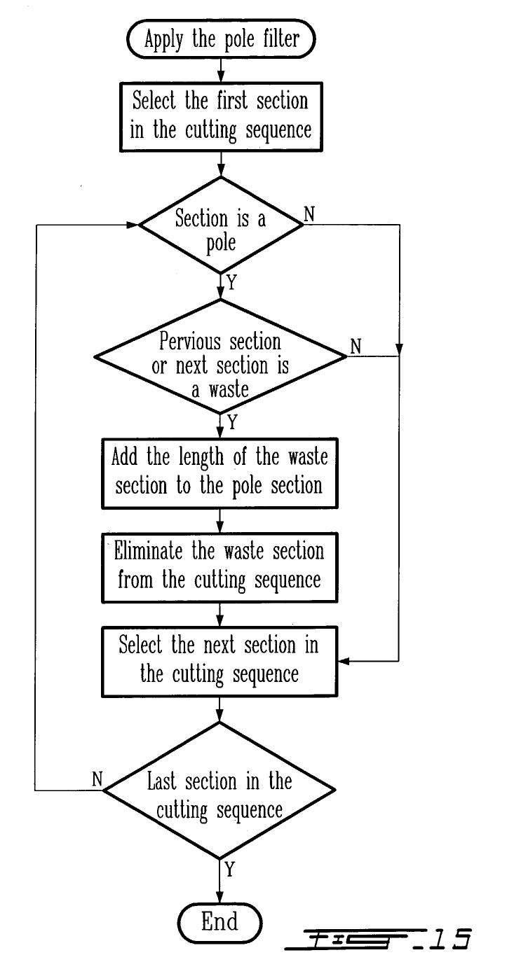

The priority optimization mode may be executed in absence of a complete model of the delimbed trunk to be cut into logs. The method using the priority mode is illustrated by the flowcharts of FIGS. 13 and 14.

In step 2220 (FIG. 13), a preset of the Presets table for the current specie is selected (step 2221 FIG. 14), and compared to determine whether the preset fits with the tree model profile (step 2222 FIG. 14). If the preset fits the tree profile, this preset is added to the cutting sequence (step 2223). Repeating the step 2222 with the same preset value allows the addition of many times this preset to the cutting sequence. When this preset cannot be used anymore as it does not fit on the rest of the log, the next preset is selected in the preset table (step 2224). The function is completed when the last preset in the table is used (step 2225).

After completing the optimization by priority in step 2220, the top log filter option is checked (step 2230). If this option is selected, the waste is evaluated in step 2231. If some waste is present, the optimization by priority is called again in step 2232 with the same three profile, reduced by the length of the top log filter value. The length of the top log is added to the cutting sequence (step 2233) at the return of the optimization by priority function (step 2232). The solution containing the less waste is used as the best cutting sequence (step 2234). The goal of the top log filter is to minimize the waste of usable fiber in the land using a minimum practical length for transportation. Mills will use this low value extra length to make wood chips is they cannot use it in a better way.

Therefore, the priority mode optimization method basically scrolls down a list of preset parameters discussed hereinafter, and elects the first one that is compatible with measured lengths and diameters in the available model of the delimbed trunk to be cut into logs. Solutions of the optimization process therefore appear according to the position where the parameters are met in the list.

As indicated, the optimization log cutting method may use preset tables (step 210). The preset tables comprise for example profiles of logs to be cut, current penalty values, predefined cutting sequences, characteristics of the end products that are desired, as will be described with more details hereinbelow. A <Preset> menu allows preset tables to be entered manually.

A first preset table, referred to as PRESETS, contains profiles of logs to be cut. The PRESET table include a number of parameters characterizing the desired logs, such as length, maximum diameter (usually at the butt of a trunk), minimum diameter (usually at the opposite top end of the trunk), value, orientation from the butt, orientation from the top, for each one of a number of different species of trees (see FIGS. 8a and 8b showing examples of presets values). These parameters are easily modified in order to meet changing requirements of specific mills.

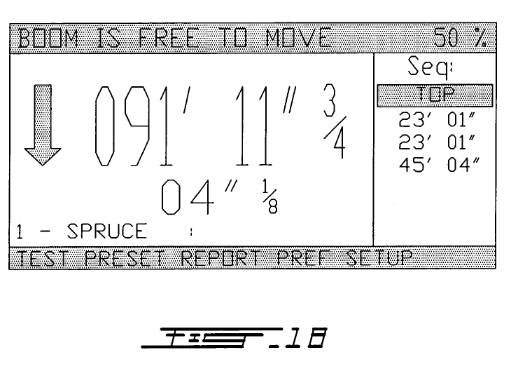

A second table, referred to as WASTE, may be used, which enables to preset penalty values to parts of a trunk whose diameter is large enough to be used but which are discarded and left on the field. Such values may correspond to fees charged by official governmental authorities or they can be fixed so as to meet a landowner's productivity targets in order to reduce the waste of fiber. The function <Min. Waste> assessing the minimal waste can generate a value <Waste Value> when activated. The <Waste Value> is essentially an amount of money by m³. In the example shown in FIG. 17, the function <Min. Waste> appears to be disabled, so that the <Waste Value> is not used as a parameter in the optimization step (even if it has a value different from 0).

A third table, referred to as PREDEFINED, may allow predefining cutting sequences that can be used whenever a given trunk has a specific profile. The characteristics may include for example minimum and maximum length, minimum and maximum diameter of the butt, minimum and maximum diameter of the top, cutting sequence.

A fourth table, referred to as POLES, may contain the characteristics of the end products that are desired. For example, it may comprise profiles for telephone poles, in terms of length, minimum and maximum diameter of the butt, minimum and maximum diameter of the top, orientation either from the butt or from the top.

When the trunk being processed is indeed one which has a cutting sequence defined in the PREDEFINED table (step 225), the method 200 may directly yield an optimization solution (step 260).

However, the method may be applied without recurring to such tables. In fact, if the trunk being processed is not one which has a cutting sequence defined in the PREDEFINED table (step 212), or if it is chosen not to use the predefined sequences (step 215), the method 200 proceeds to an optimization (step 220) either based on value (step 224) (see FIGS. 10-12) or on priority (step 222, FIGS. 13-14), to yield an first optimization solution (step 226).

It is to be noted that the method allows to input an exact dollar value of a preset, which is the exact value in $/m³ that a mill offers for a log of a given specie and meeting specific criteria of length and diameters. Alternatively, a satisfactory result can be obtained without the knowledge of this exact dollar value. In this case, the method provides that a user be warned that certain lengths should be favored that are more valuable. By thus giving a relative value to each of the “preset,” it is possible to assign them an adequate priority.

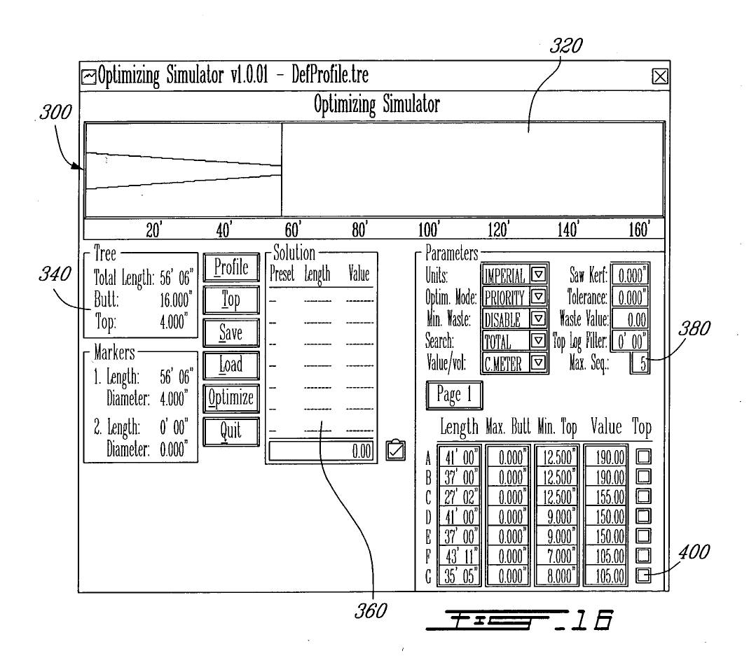

If this first optimization solution does not comprise a pole, then it is the optimization solution (step 260). If it does comprise a pole, a pole filter is applied (step 230, FIG. 15), to further eliminate wastes between successive logs, which may occur when a minimal and a maximal diameters between two logs limit the optimization of the use of a trunk. In cases of posts or poles, mills generally accept lengths greater than ordered. Even though these extra lengths are not paid for by the mills, such a practice results in the harvester not having to face the fees charged by governmental authorities in relation to usable fiber wasted in the land, as mentioned hereinabove. Moreover, mills reprocess the extra lengths in the form of wood chips.

In relation to the value mode optimization (step 224, FIGS. 10-12), it is to be noted that the value optimization according to the present method is based on a recursive process, whereby all combinations of presets in a cutting sequence may be tried until either all presets have been tested or a maximum number of log sections allowed in a sequence have been reached. However the method 200 allows to discard combinations that are considered highly unrealistic based on experience in order to accelerate the optimization rate, as will be described further hereinbelow.

Therefore, given a model of a trunk as available after a trimming process performed by the delimbing machine 12 as described hereinabove for example, the method of the present invention may be launched by chopping off the top 32 or an action by an operator through the control unit of the delimbing machine 12, yielding log cutting solutions in terms of lengths that can be obtained in relation to costs thereof. The optimized solutions may be displayed on a screen for example. The operator may then, either manually or automatically, drive the boom 22 back to optimized localizations along the delimbed trunk 14 as determined by the computation and activate the cutting of logs at those localizations.

From the foregoing, it should now be apparent that the present invention provides a method for optimization log cutting whereby an operator is allowed to monitor at all times, on a screen for example, the distance between the butt (refers to an end having a larger diameter) of a delimbed tree trunk and a top saw, as well as the distance separating a last cut section and the top saw. In particular, automatic and quick interruptions are possible at all times.

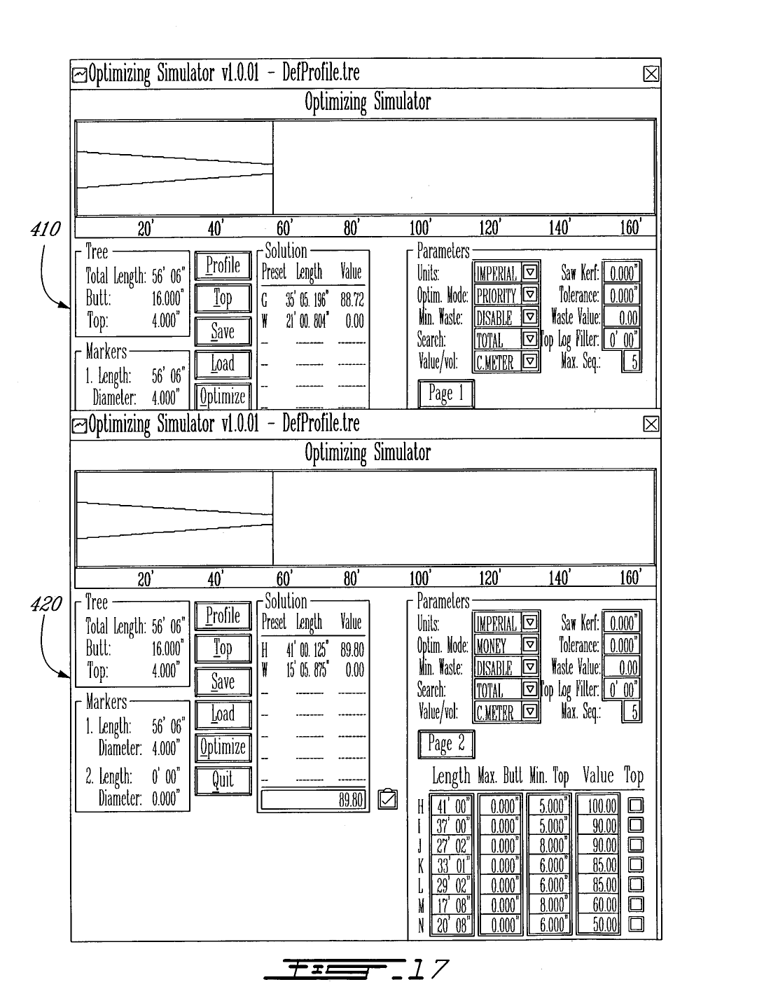

Interestingly, the present invention provides a system operating the above described method and allowing to carry on tests through an interface display (FIGS. 16-17). An interface display 300 may comprise for example the following features:

a visualization window 320, in which a model of the trunk being considered is displayed;

a “Tree” window 340, which permits to input the length of the trunk, the butt diameter and the top diameter thereof;

a “Solution” window 360, which displays results from the optimization performed by the simulator, in terms of length and monetary value;

a “Parameters” window 380, which displays the parameters required both for the visualization and for the selection of an optimization mode;

a table 400, for the input of the values contained in a table PRESETS described hereinabove; and

a series of push button, such as Profile, Top, Save, Load, Optimize and Quit for example.

The “Parameters” window 380, may be used to perform the following actions:

to elect either imperial or metric units (“Units”);

to choose between a value or a priority optimization mode (“Optim.

Mode”);

to enable or disable the use of the Waste Value described hereinabove (“Min. Waste”) (disabling the function “Min. Waste” is equivalent to set the <Waste Value> to 0 $/m³);

to select the degree of optimization (“Search”), in order to allow a higher optimization rate as mentioned hereinbefore. It may be “Total”, involving consideration of all combinations that can be considered as solutions in order to sort out the optimal solution, and therefore being a rather slow process. It may alternatively be “Partial”, resulting in a satisfactory optimization in a time reduced by a factor comprised between 3 and 20. In practice, it is found that the “Total Search” alternative does not yield a considerable improvement for all practical matters;

to choose whether the monetary values stored in the tables apply to m³ (“Value/vol.:” set to “<C. METER>”), or to bd-ft (board foot, i.e. 1′×1′×1″) (“Value/vol.:” set to “<BRDFOOT>”);

to define the width of the saw in order to take it into account in the optimization process (“Saw Kerf”). Indeed, the width of a saw can standardly arise to 0.375″, which can result, after three logs cut off a trunk for example, to a cumulative error greater than 1″;

to determine the minimum tolerance (“Tolerance”) to be respected on the length of logs, in order to accelerate the positioning of the saw to the cutting location without creating a cumulative error;

to determine the monetary penalty (“Waste Value”) to be applied to parts of a trunk which diameter is large enough to be used but which are discarded and left on the field, as discussed hereinabove;

to force a minimum length for a last log cut out of a trunk to be set to a value, for example 17, in order to eliminate wastes (“Top Log Filter”). As people in the art will be aware, in the case when the priority mode is selected, wastes often arise due to tops of trunks that are too short to be delivered to a mill. In particular, standard trucks used in Western Canada, for example, require a minimum length of 17. Such a functionality according to an aspect of the present invention may be very beneficial, particularly as last logs cut our of trunks is usually of an unspecified length or random length and has little value, used generally to make chips. In certain provinces of Canada, in particular, penalties on wastes are so high that it often result more beneficial to loose money on the logs cut before the last than to afford wastes on the last log. It is to be noted that the value of the Top Log Filter can be modified according top the specific needs of a region; and

to determine a maximum number of cuttings in a cutting sequence (“Max. Seq.”) according to specific needs. Reducing this value can result in a minimization of the time taken for the optimization process, and allows setting a sensible default value without risks of not meeting the requirements of every user.

The table 400 corresponds to an input menu available of the delimbing machine according to the present invention, where the following parameters may be inputted

Length: refers to the length of a desired log;

Max. Butt: refers to a maximum diameter of the butt of a log;

Min. Top: refers to a minimum diameter of the top of a log;

Value: refers to the monetary value in $/m³ or in $/board foot; and

Top: allows to precise whether a log must be considered from the butt or from the top. Generally, all logs are cut off from the butt. However, in specific applications, such as fence poles for example, it is preferred to cut off logs from the top, which corresponds to a less valuable part of a trunk while having an adequate diameter for the given purpose.

It is to be noted that the delimbing machines used in the field may not be provided with such a visualization window 320, and that, provided the trunk is modeled during the delimbing stage, none of these parameters need to be inputted through such a “Tree” window 340 since they are part of the model of the trunk available by the end of the delimbing stage. Additionally, since the delimbing machines used in the field are usually provided with small-sized monitor units, the results displayed in the “Solution” window 360 may not be displayed in practice. Therefore the system of the present invention may only comprise a unit performing the method of the present invention as described hereinbefore in relation to FIGS. 7-14, including for example an equivalent of the Optimize button provided in the monitor unit of the delimbing machines.

In FIG. 17, as a way of example, a 56 feet 06 inches stem is considered, and the results are presented according to the priority mode (top half 410) and to the value mode (bottom half 420). While the priority mode suggest cutting a log worth $88.72, the value mode optimization results in a log worth $89.80, for example, which amounts to $1.08 more for that particular tree, but which can represent valuable extra income considering that a delimber machine standardly processes 500 stems a day.

FIG. 18 illustrates an example of a display provided on a system of according to a possible embodiment of the present invention, comprising a delimbing machine 12 for example, as could be used in the field. In the exemplary case of where spruce is selected as the species of the tree are displayed the length of the trunk under processing (91′11″¾) and the diameter of the trunk at the place where the delimbing arms are located (4″⅛). In the right hand side of the screen appears an optimal cutting sequence as determined by the method of the present invention implemented in the delimbing machine. Here, the result states that, from the top, the trunk is to be cut into three logs, namely at 23.01 inches, 23 feet 01 inches and 45 feet 04 inches. It is to be noted that the optimization method is independent of a display used, meaning that such a user interface can be completely modified without modifying the optimization process used.

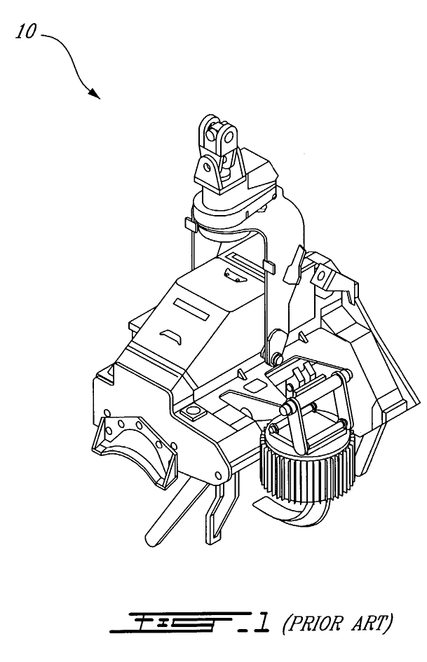

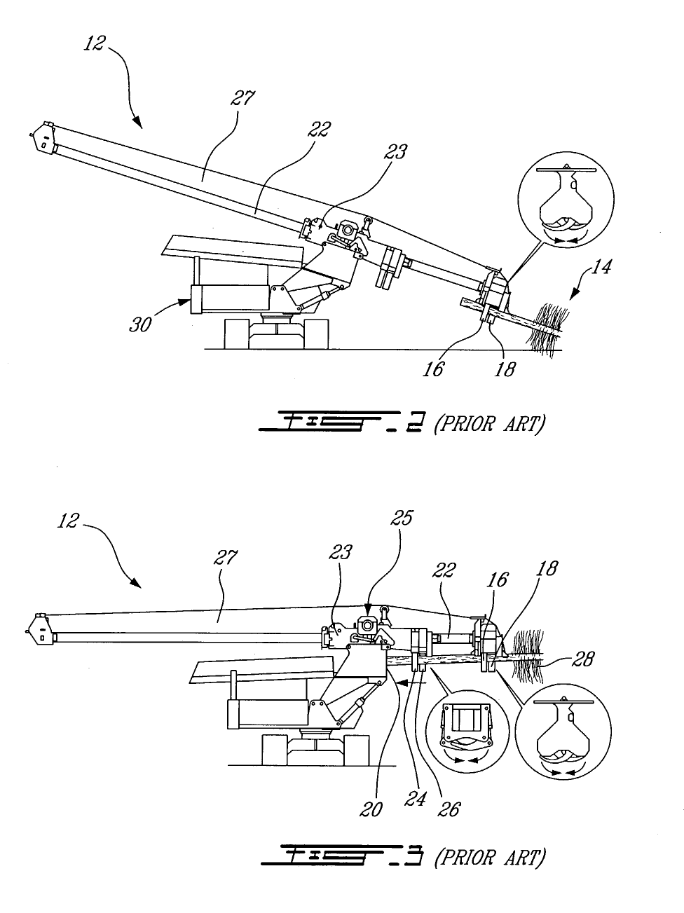

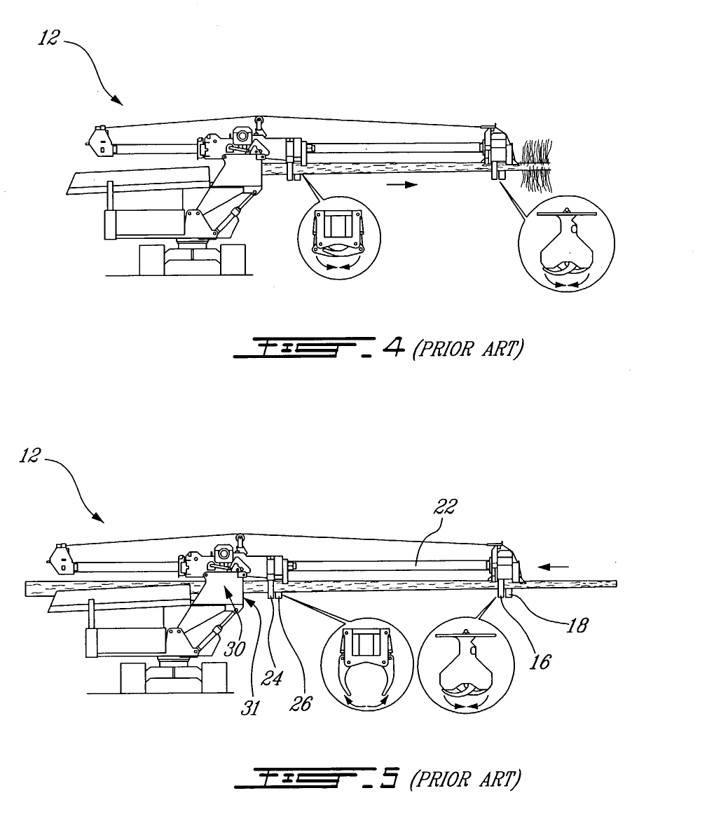

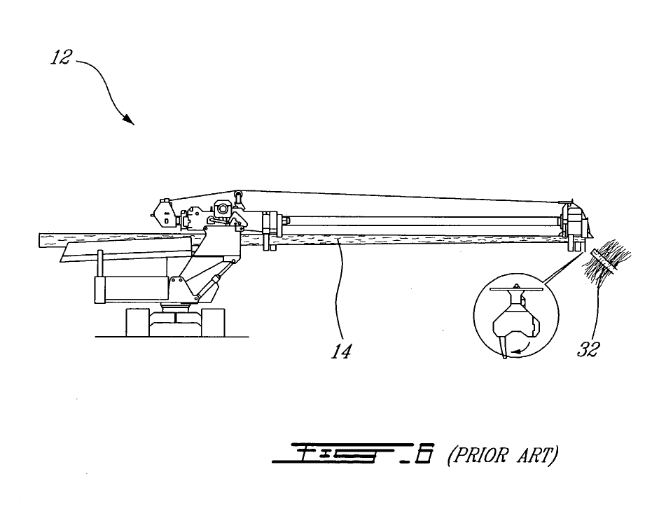

From the foregoing, people in the art will now appreciate that the method of the present invention, when applied in cases when the delimbing stage is performed by a harvesting head such as shown in FIG. 1 allows improved optimization. In cases when a complete model of a trunk is available, for example when the delimbing stage is performed by a delimbing machine as illustrated for example in FIGS. 2-6, the method of the present invention is even more effective, allowing log cutting decisions to be made efficiently and safely without being impaired by errors due to operators.

Although the present invention has been described hereinabove by way of possible embodiments thereof, it can be modified, without departing from the nature and teachings of the subject invention as defined in the appended claims.

What is claimed is:

1. A method for optimizing log harvesting from a model of a delimbered tree trunk, comprising the steps of:
selecting an optimization mode; and
obtaining an optimized log cutting solution,
whereby the optimized log cutting solution indicates optimized localizations along the delimbed tree trunk.

2. The method according to claim 1, wherein said selecting an optimization mode comprises selecting a mode in the group comprising a priority mode and a value mode.

3. The method according to claim 1, wherein said obtaining an optimized log cutting solution comprises the substeps of a value mode.

4. The method according to claim 1, wherein said obtaining an optimized log cutting solution comprises the substeps of a priority mode.

5. The method according to claim 1, further comprising the step of applying a pole filter.

6. The method according to claim 1, further comprising the step of using predefined cutting sequences prior to said selecting step of an optimization mode.

7. The method according to claim 1, wherein said obtaining an optimized log cutting solution comprises using predefined tables.

8. A log cutting optimization method comprising the steps of:
providing a model of a delimbed tree trunk to be cut into logs, the model comprising a length of the delimbed tree trunk and a diameter of each section thereof;
selecting an optimization mode; and
obtaining an optimization solution.

9. The log cutting optimization method according to claim 8, wherein said selecting an optimization mode comprises selecting a mode in the group comprising priority mode and value mode.

10. The log cutting optimization method according to claim 8, wherein said obtaining an optimization solution comprises applying a pole filter.

11. The log cutting optimization method according to claim 8, wherein said computing an optimized log cutting strategy further comprises using predefined tables.

12. A system for optimizing log harvesting using a method for optimizing log harvesting, the method including selecting an optimization mode, comprising:
a model of a delimbered tree trunk; and
means for obtaining an optimized log cutting solution,
whereby the optimized log cutting solution indicates optimized localizations along the delimbed tree trunk.

13. The system according to claim 12, wherein said selecting an optimization mode comprises selecting a mode in the group comprising a priority mode and a value mode.

14. The system according to claim 12, wherein said obtaining an optimized log cutting solution comprises the substeps of a value mode.

15. The system according to claim 12, wherein said obtaining an optimized log cutting solution comprises the substeps of a priority mode.

16. The system according to claim 12, further comprising the step of applying a pole filter.

17. The system according to claim 12, further comprising the step of using predefined cutting sequences prior to said selecting step of an optimization mode.

18. The system according to claim 12, wherein said obtaining an optimized log cutting solution comprises using predefined tables.

19. A system for optimizing log harvesting using a log cutting optimization method comprising:
a model of a delimbed tree trunk to be cut into logs, the model comprising a length of the delimbed tree trunk and a diameter of each section thereof;
the method including selecting an optimization mode, and obtaining an optimization solution.

20. The log cutting optimization system according to claim 19, wherein said selecting an optimization mode comprises selecting a mode in the group comprising priority mode and value mode.

21. The log cutting optimization system according to claim 19, wherein said obtaining an optimization solution comprises applying a pole filter.

22. The log cutting optimization system according to claim 19, wherein said obtaining an optimization solution comprises using predefined tables.
